(19) United States
(12) Patent Application Publication
(10) Pub. No.: US 2018/0227502 A1
(43) Pub. Date: Aug. 9, 2018

(54) SYSTEMS AND METHODS FOR REDUCED POWER CONSUMPTION IN IMAGING PIPELINES

(71) Applicant: QUALCOMM Incorporated, San Diego, CA (US)

(72) Inventor: Assaf Menachem, Yokneam Illit (IL)

(21) Appl. No.: 15/425,137

(22) Filed: Feb. 6, 2017

(51) Int. Cl. H04N 5/265; H04N 5/232; H04N 5/907

(52) U.S. Cl. CPC H04N 5/265; H04N 5/23258; H04N 5/23241; H04N 5/907; H04N 5/23267

(57) ABSTRACT

Methods and systems for reducing power in an image pipeline are disclosed. In one aspect, a method includes receiving, by an electronic device, a first image stream from an imaging sensor at a first frame rate, receiving, by the electronic device, measurements from a motion sensor at a rate greater than or equal to the first frame rate, generating, by the electronic device, a second image stream from the first image stream, the second image stream having a second frame rate less than the first frame rate, modifying, via an imaging pipeline of the electronic device, the second image stream at the second frame rate, generating, by the imaging pipeline, new frames based on the measurements and the second image stream, and generating a third image stream by inserting the new frames into the second image stream so as to achieve a frame rate greater than the second frame rate.

### BACKGROUND

### Field

This technology relates to image processing, and more specifically to image pipelines utilizing less power for a given frame rate.

### Description of the Related Art

Video resolution and frame rates are growing exponentially. While these advances improve the user experience, they also present several challenges to device manufacturers, including increased power consumption. Given the finite amount of power available on a mobile device, improved methods and systems are needed that deliver the video resolution and frame rates allowed by modern hardware capabilities while ensuring these hardware capabilities do not adversely impact the user experience with regard to power consumption and therefore, in some aspects, battery life.

### SUMMARY

The systems, methods, and devices of the invention each have several aspects, no single one of which is solely responsible for its desirable attributes. Without limiting the scope of this invention as expressed by the claims which follow, some features will now be discussed briefly. After considering this discussion, and particularly after reading the section entitled “Detailed Description,” one will understand how the features of this invention provide advantages that include reduced power consumption.

One innovation includes an electronic device including an imaging sensor (also referred to as an “image sensor”), a motion sensor configured to measure accelerations of the apparatus (or the imaging sensor), an electronic hardware memory, and a first electronic processor operably coupled to the imaging sensor. The first electronic processor may be configured to receive image frames from the imaging sensor at a first frame rate, perform front-end processing on a first portion of the image frames received from the imaging sensor, the first portion having a second frame rate less than the first frame rate, write the processed frames to the electronic hardware memory at the second frame rate, drop a remaining portion of the frames, enter a low power state in response to dropping a frame, and exit the low power state in response to a capture of a next frame at the first rate by the imaging sensor. The electronic device further includes a second electronic hardware processor, configured to receive the frames from the electronic memory at the second frame rate, perform back-end processing on the received frames, generate new frames based on the frames received from the electronic memory and the measurements, and write the processed frames and new frames to the memory at a rate higher than the second frame rate based on the received frames and the generated new frames.

One aspect disclosed is an electronic device. The device includes an image sensor, a motion sensor, configured to measure accelerations of the image sensor, an electronic hardware memory, a first electronic processor, operably coupled to the image sensor, and configured to receive image frames from the image sensor at a first frame rate, perform front-end processing on a first portion of the image frames received from the image sensor, the first portion having a second frame rate less than the first frame rate, write the processed frames to the electronic hardware memory at the second frame rate, drop a remaining portion of the frames, enter a low power state in response to dropping a frame, and exit the low power state in response to a capture of a next frame at the first rate by the image sensor, a second electronic hardware processor, configured: receive the frames from the electronic memory at the second frame rate, perform back-end processing on the received frames based on the measurements, generate new frames based on the frames received from the electronic memory and the measurements, and write the processed frames and new frames to the memory at a rate higher than the second frame rate based on the received frames and the generated new frames.

In some aspects, the first electronic hardware processor is configured to vary a percentage of frames dropped based on a level of motion detected in the received frames. In some aspects, the front-end processing includes one or more of black-level correction, channel gains, demosaic, Bayer filter, global tone mapping, color conversion, and wherein the back-end processing comprises one or more of spatial de-noising, temporal de-noising, stabilization, lens distortion correction, sharpening, and color processing. In some aspects, the second electronic hardware processor is configured to generate new frames by: generating a stabilization transform based on the measurements, extrapolating local motion vectors in previous frames; and adapting a previous frame based on the extrapolated local motion vectors and the stabilization transform to generate a new frame. In some aspects, entering a low power state comprises clock gating the first electronic hardware processor. In some aspects, back-end processing comprises one or more of stabilization, lens distortion correction, temporal de-noising, spatial de-noising, local tone mapping, gamma correction, color enhancement, and sharpening

Another aspect disclosed is a wireless device with improved power consumption characteristics. The device includes an electronic memory, a motion sensor, an image sensor configured to operate at a first frame rate using a first exposure time, a front end hardware processor, configured to process frames from the image sensor at a second rate lower than the first frame rate and write the processed frames to the electronic memory and to enter a lower power state between a time that the processing completes on a first frame and a next second frame is received from the image sensor at the lower rate; and a back-end hardware processor, operably connected to the electronic memory, and configured to process frames received from the front end processor via the memory at the second rate and to frame rate up convert the received frames based on measurements of the motion sensor to achieve the first frame rate. In some aspects, the back-end hardware processor is configured to up convert the received frames by: receiving a frame from the front end processor, copying the frame to generate a second frame, stabilizing the received frame using a first stabilization transform derived from a first set of measurements from the motion sensor; and stabilizing the second frame using a second stabilization transform derived from a second set of measurements from the motion sensor.

In some aspects, the front end hardware processor is configured to vary the second rate at which frames from the image sensor are processed based on a level of motion detected in the frames, and wherein the back-end hardware processor is configured to vary the rate of frame rate up conversion to achieve the first frame rate based on the variable rate of frames received from the front-end processor. In some aspects, the device also includes a battery, and the electronic hardware memory, image sensor, front end hardware processor, and back-end hardware processor are configured to draw power from the battery.

Another aspect disclosed is a method of reducing power consumption in an imaging device. The method includes receiving, by an electronic device, a first image stream from an image sensor at a first frame rate, receiving, by the electronic device, measurements from a motion sensor at a rate greater than or equal to the first frame rate, generating, by the electronic device, a second image stream from the first image stream, the second image stream having a second frame rate less than the first frame rate, modifying, via the electronic device, the second image stream at the second frame rate, generating, by the imaging pipeline, new frames based on the second image stream, stabilizing the new frames based on the a portion of the measurements, stabilizing the second image stream based on a second different portion of the measurements; and generating, by the electronic device, a third image stream by inserting the stabilized new frames into the stabilized second image stream so as to achieve a frame rate greater than the second frame rate.

In some aspects, the method includes generating local motion vectors based on at least two frames in the second image stream; and generating a first new frame of the new frames based on the local motion vectors applied to a most recent frame of the at least two frames. In some aspects, the method periodically drops frames in the first image stream to generate the second image stream. In some aspects, the method includes varying the periodicity of the frame dropping based on a level of motion detected in the second image stream, wherein a rate of generation of new frames is configured to adjust such that the third image stream achieves a stable frame rate as the periodicity of frame dropping varies. In some aspects, the method includes modifying the second image stream comprises modifying one or more frames of the second image stream, wherein modifying comprises one or more of Bayer filtering, demosaicing, black-level correction, adjusting channel gains, global tone mapping, and color conversion.

Another aspect disclosed is an apparatus for reducing power consumption in an imaging device. The apparatus includes an electronic hardware processor, an electronic hardware memory, operably coupled to the processor, and storing instructions that when executed cause the processor to: receive a first image stream from an image sensor at a first frame rate, receive measurements from a motion sensor at a rate greater than or equal to the first frame rate, generate a second image stream from the first image stream, the second image stream having a second frame rate less than the first frame rate, modify the second image stream at the second frame rate, generate new frames based on the second image stream, stabilize the second image stream based on a portion of the measurements, stabilize the new frames based on a different second portion of the measurements, and generate a third image stream by inserting the new frames into the second image stream so as to achieve a frame rate greater than the second frame rate.

In some aspects of the apparatus, the electronic hardware memory further stores instructions that cause the electronic hardware processor to: generate local motion vectors based on at least two frames in the second image stream; and generate a first new frame of the new frames based on the local motion vectors applied to a most recent frame of the at least two frames. In some aspects of the apparatus, the electronic hardware memory further stores instructions that cause the electronic hardware processor to periodically drop frames in the first image stream to generate the second image stream. In some aspects of the apparatus, the electronic hardware memory further stores instructions that cause the electronic hardware processor to: vary the periodicity of the frame dropping based on a level of motion detected in the second image stream, wherein a rate of generation of new frames is configured to adjust such that the third image stream achieves a stable frame rate as the periodicity of frame dropping varies.

In some aspects of the apparatus modifying the second image stream comprises modifying one or more frames of the second image stream, wherein modifying comprises one or more of Bayer filtering, demosaicing, black-level correction, adjusting channel gains, global tone mapping, and color conversion.

### BRIEF DESCRIPTION OF THE DRAWINGS

The various features illustrated in the drawings may not be drawn to scale. Accordingly, the dimensions of the various features may be arbitrarily expanded or reduced for clarity. Furthermore, dotted or dashed lines and objects may indicate optional features or be used to show organization of components. In addition, some of the drawings may not depict all of the components of a given system, method, or device. Finally, like reference numerals may be used to denote like features throughout the specification and figures.

FIG. 1 shows examples of unstabilized and stabilized image streams.

FIG. 2 shows examples of an alternate form of unstabilized and stabilized image streams.

FIG. 3 is a data flow diagram for increasing a frame rate according to one or more of the disclosed embodiments.

FIG. 4 is a view of an exemplary imaging pipeline 400.

FIG. 5 is another view of the exemplary imaging pipeline 400.

FIG. 6 is a timing diagram showing relative timing of acceleration measurements, processing of frames by an imaging pipeline, and an output image frame stream from the imaging pipeline.

FIG. 7 is a flowchart for reducing power in an imaging pipeline.

FIG. 8 is a flowchart illustrating an example of a method of reducing power in an imaging pipeline.

FIG. 9 is a flowchart illustrating an example of a method of reducing power in an imaging pipeline.

FIG. 10 is a flowchart illustrating an example of a method of stabilizing a frame in an imaging pipeline.

### DETAILED DESCRIPTION

Various aspects of the novel systems, apparatuses, and methods are described more fully hereinafter with reference to the accompanying drawings. The teachings disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect disclosed herein may be embodied by one or more elements of a claim.

Furthermore, although particular aspects are described herein, many variations and permutations of these aspects fall within the scope of the disclosure. In addition, the scope of the disclosure is not intended to be limited to particular the benefits, uses, or objectives disclosed herein. Rather, aspects of the disclosure are intended to be broadly applicable to different wired and wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

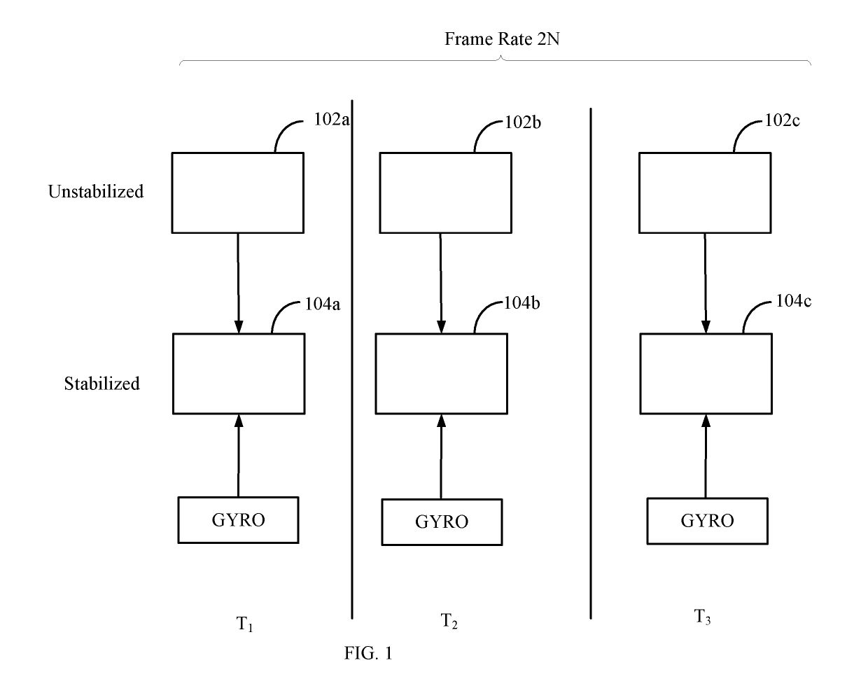

FIG. 1 shows examples of unstabilized and stabilized image streams that may be, for example, produced by an image sensor of an imaging device. The unstabilized images 102a-c may be captured at three distinct times, shown as T₁-T₃ in FIG. 1, respectively. Each image 102a-c is stabilized using gyroscope (“gyro”) information determined at substantially similar times T₁-T₃ respectively to produce stabilized images 104a-c. In other words, while each of images 102a-c are captured at times T₁-T₃, respectively, gyroscope information is also determined at the same times T₁-T₃, or at substantially the same times, and the gyroscope information is used to produce stabilized images.

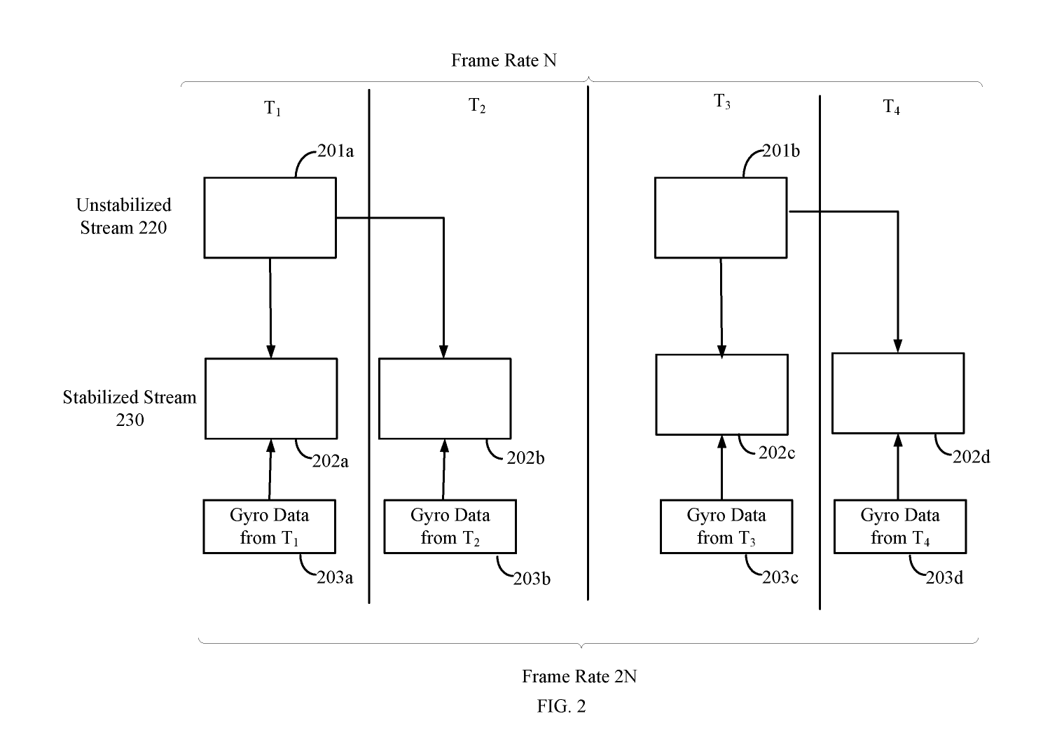

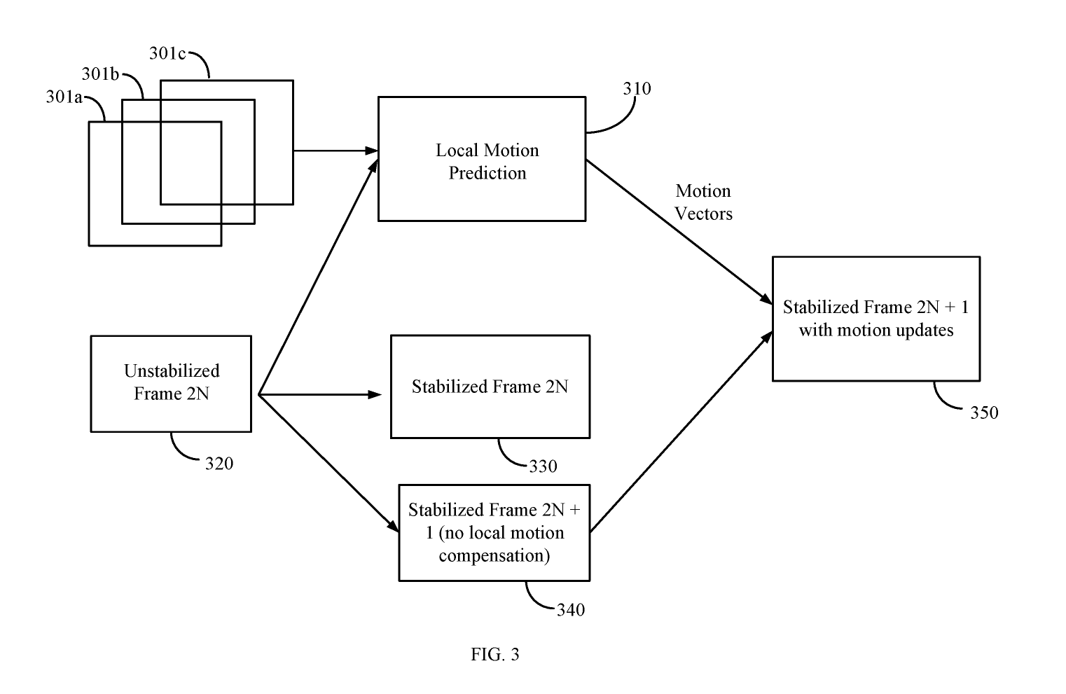

FIG. 2 shows an alternate form of examples of embodiments of unstabilized and stabilized image streams. Unstabilized image frames 201a and 201b are included in a stream of image frames 220 having a frame rate of N. The frame stream 220 may be captured by an imaging sensor at a frame rate of N or another frame rate greater than N or less than N in some aspects. The unstabilized image frames are used to produce a stream of stabilized image frames 230 including frames 202a-d. Each of the stabilized image frames 202a-d is stabilized using data received from an accelerometer or gyro. The data from the accelerometer or gyro used to stabilize each frame in the stabilized stream 230 measures motion of the imaging sensor at a time corresponding to the stabilized frames respective position in the stabilized stream 230. For example, whereas both of image frames 202a and 202b may be derived from unstabilized image 201a, frame 202a may be stabilized based on acceleration data measured at time T₁ while frame 202b may be stabilized based on acceleration data measured at time T₂.

Whereas in FIG. 1, a one to one ratio existed between the unstabilized image frames 102a-c and the stabilized image frames 104a-c, in FIG. 2, the ratio between unstabilized image frames 201a-b in the unstabilized stream 230 and stabilized image frames 202a-d in the stabilized stream is not one to one. For example, in the exemplary image streams 220 and 230 of FIG. 2, the ratio is one unstabilized image frame for every two stabilized image frames. Thus, while the unstabilized image stream 220 has a frame rate of “N”, the stabilized image stream 230 has a frame rate of 2N. Thus, both the sequence of stabilized frames 104a-c and 204a-c of FIGS. 1 and 2 have the same frame rate of 2N. In contrast, while the unstabilized frames of FIG. 1 102a-c also have a frame rate of 2N, the unstabilized frames of FIG. 2 202a-c have a lower frame rate of N. By reducing the frame rate of unstabilized frames, while maintaining an equivalent rate for stabilized frames, the disclosed methods and systems may provide for reduced power consumption in an imaging pipeline. For example, in some aspects, an image pipeline generating image frames according to FIG. 3 may consume less power than an image pipeline generating the image frames according to FIG. 2.

FIG. 3 is a data flow diagram for increasing a frame rate according to one or more of the disclosed embodiments. FIG. 3 shows a series of frames 301a-c. The series of frames 301a-c may be used to generate motion vectors that predict motion in a frame that follows frames 301a-c in an image frame sequence, such as frame 350.

Frame 350 is derived from an unstabilized frame 2N 320, which may represent an image of a scene as captured by an imaging sensor. Frame 2N may undergo an image stabilization process, for example, based on input provided by an accelerometer or gyro, to produce the stabilized frame 2N 330.

Frame 320 may also be used to produce stabilized frame 2N+1, first, via a stabilized version of frame 320 shown as frame 340. Whereas the stabilized frame 2N 330 may be stabilized based on acceleration data measured at a first time, the stabilized frame 2N+1 340 may be stabilized based on acceleration data measured at a different second time, as discussed above with respect to FIG. 2.

Stabilized frame 2N+1 306 may be further based on local motion vectors 320 generated based on image frame sequence 301a-c. In some aspects, the unstabilized frame 2N 320 may be included in the image frame sequence 301a-c.

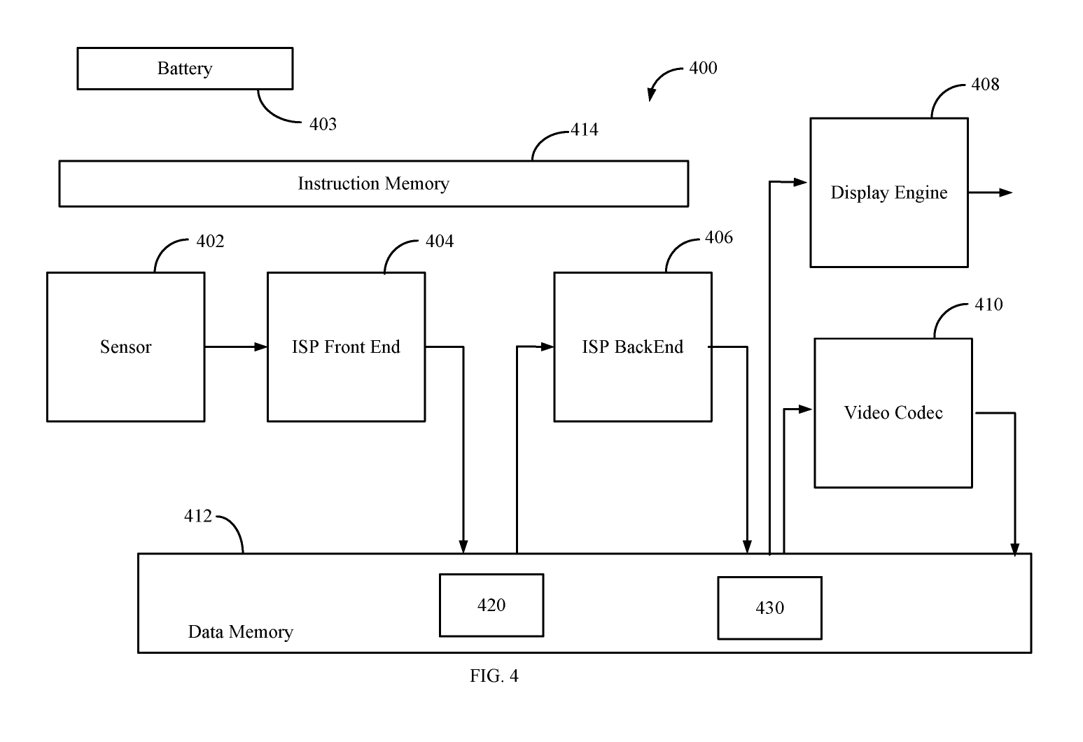

FIG. 4 shows an exemplary imaging pipeline 400 according to at least one embodiment. The imaging pipeline 400 includes an imaging sensor 402, a front end component 404, back end component 406, display engine 408, and a video codec 410. Also shown are a battery 403 and two electronic hardware memories 412 and 414. In some aspects, the imaging sensor 402 may be included in a camera 401. The camera 401 may include components such as one or more of a flash/illumination device, a lens, a mass storage device, a viewfinder, and a shutter release. Various aspects of the disclosed embodiments may include all or only a portion of the components shown in FIG. 4. In some aspects, each of the sensors, components, engines, memories, or codecs illustrated in FIG. 4 may be configured to draw power from the battery 403.

One or more of the sensors, front end component 404, back-end component 406, display engine 408, and video codec 410 may include an electronic hardware processor, and can also be referred to as a central processing unit (CPU). Memories 412 and 414, which can include both read-only memory (ROM) and random access memory (RAM), may provide instructions and data to the processor or any one or more of the sensors, components, engines, or codecs discussed above. A portion of the memories 412 and/or 414 can also include non-volatile random access memory (NVRAM). The sensors, components, engines, or codecs may perform logical and arithmetic operations based on program instructions stored within the memory 414. In alternative embodiments, program instructions may be stored within the sensor, component, engine or code itself. The program instructions described above can be executable to implement the methods described herein.

One or more of the sensors, components, engines, or codecs described above can comprise or be a component of a processing system implemented with one or more processors. The one or more processors can be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

In some aspects, each of the sensor 402, front-end component 404, back-end component 406, display engine 408, and video codec 410 may be individual hardware circuits, or collections of hardware circuits, configured to perform one or more functions. For example, in some aspects, one or more of these sensors, components, engines, codecs, may be separate hardware components that are operably connected to one or more other components via an electronic bus. Alternatively, one or more of these components and engines may represent instructions stored in a memory such as instruction memory 414. The instructions may configure one or more hardware processors to perform one or more of the functions attributed to each of the sensors, components/engines/or codecs discussed below.

In various embodiments, the front-end 404 may perform one or more functions. This may include operating on Bayer format data (R, Gr, Gb, B) from the imaging sensor, aligning gains of different Bayer channel, such as (Red, Gr, Gb, and Blue), high dynamic range processing, bad pixel correction, Bayer noise filtering, lens shading correction, white balance, and demosaic. The demosaic process may generate RGB data from the Bayer data in some aspects. When operating on RGB data, the front-end 404 may perform color correction, global tone mapping, and color conversion, which may convert the RGB data to YUV data. When operating on YUV data, the front end 404 may convert the data to YUV420 data, and may also perform one or more of downscaling and cropping. In some aspects, the front-end 404 may also generate an image that includes marginal areas. In some aspects, the margins may represent 20% of the image elements in each axis.

The ISP Back-End 406 may perform one or more functions. These functions may include one or more of warping (which may include stabilization, lens distortion correct), temporal de-noising, spatial de-noising, local tone mapping, gamma, color enhancement, sharpening.

Several of the imaging pipeline components write data to the electronic hardware memory 412. For example, the ISP front end 404, ISP back end 406, and video codec 410 may write image frame data to the memory 412. In some aspects, the memory 412 may be double data rate (DDR) memory. For example, the ISP front end 404 may write the image frame 420 to the memory 412. The image frame 420 may then be read from the memory 412 by the ISP backend 406. After processing is completed, the ISP back end may write a modified form of the image frame 420 to the memory 412 as image frame 430. Image frame 430 may then be read from the memory 412 by the display engine and separately by the video codec 410 in at least some aspects. Writing and reading of the image frames 420 and 430 may consume substantial amounts of power. The power consumed is proportional to the frame rate at which the ISP front end 404 and ISP back end 406 process image frames. To the extent the frame rate of the ISP front end 404 and/or the ISP back end 406 can be reduced, power consumption of the imaging pipeline 400 is also reduced.

The processing system can also include machine-readable media for storing software. Software shall be construed broadly to mean any type of instructions, whether referred to as software, firmware, middleware, microcode, hardware description language, or otherwise. Instructions can include code (e.g., in source code format, binary code format, executable code format, or any other suitable format of code). The instructions, when executed by the one or more processors, cause the processing system to perform the various functions described herein.

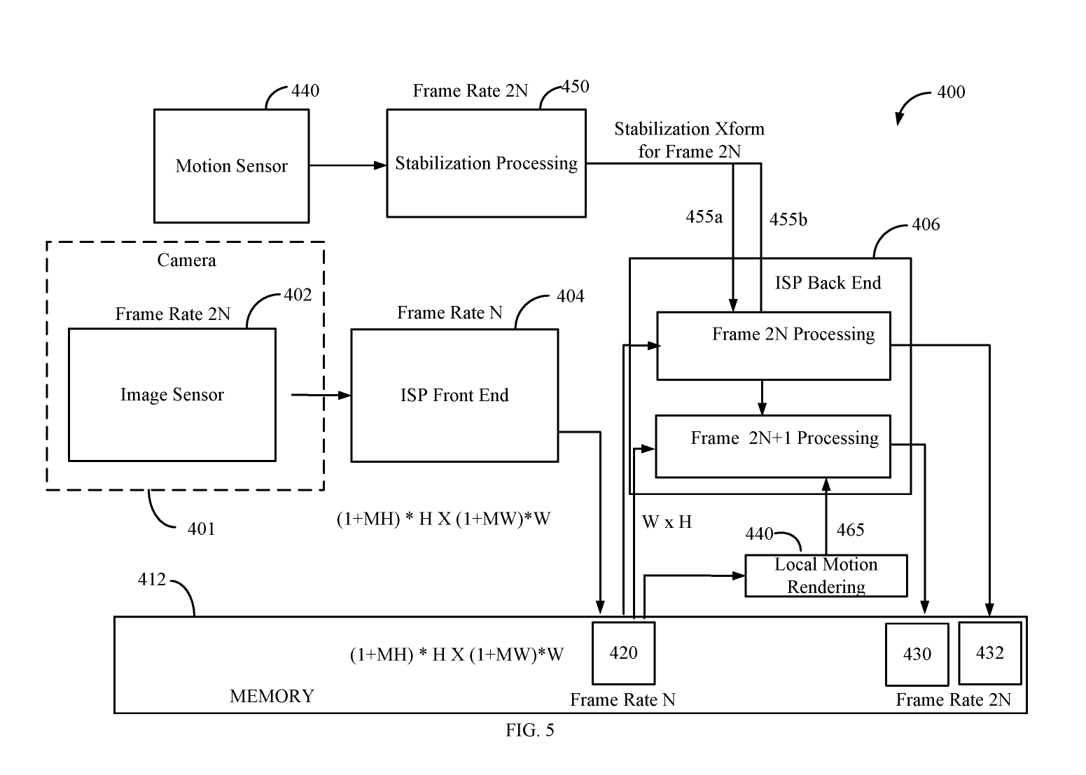

FIG. 5 is another view of the exemplary imaging pipeline 400. FIG. 5 shows that the ISP Front End 404 may generate frame data 420 and write the frame data to a memory 412. The frame data 420 may have a height (H) and a width (W) dimension. The frame data 420 may include margin data on a vertical top and a vertical bottom of the frame data. This margin data may be used to facilitate stabilization of the frame data 420. The size of the margin data on the top and bottom is shown as MH in FIG. 5. Thus, the total height of the frame is 1+MH*H. The frame data 420 may also include margin data on each side of the frame data. This may also be used to facilitate stabilization of the frame data 420. Thus, the total width of the frame is 1+MW*W. The value of MH and MW may vary by embodiment. For example, in various aspects, the value of MH and/or MW may be 0.02, 0.05, 0.1, 0.15, 0.2, 0.25 or any value.

In some aspects, the margin data may be outside the field of view in some frames and within the field of view in other frames depending on the particular stabilization need for a particular frame. For example, if a frame is captured from a relatively low perspective, margin data at the top of the frame may be brought into the field of view, whereas if the frame is captured from a relatively higher perspective, margin data at the bottom of the frame may be brought into the field of view in order to better stabilize the frame. The dimensions of the frame data 420 are shown in FIG. 5 as a field of view length plus a margin size by a field of view width value.

The exemplary imaging pipeline 400 of FIG. 5 also includes a motion sensor 440. The motion sensor 440 may include one or more of an accelerometer and a gyro. The motion sensor 440 measures accelerations of the imaging sensor 402. The measurements from the motion sensor 440 may be processed by an image stabilizer component 450 to generate stabilization transforms 455a-b.

Still referring to FIG. 5, the ISP back end 406 may read from the memory 412 a subset of the frame data 420 written to the memory 412 by the ISP front end 404. For example, the subset of frame data 420 read by the ISP back end 406 may be based on acceleration transforms 455a and 455b generated by an image stabilizer 450. For example, the ISP back end 406 may generate a first frame 430 based on frame data 420 and acceleration transform 455a. The ISP back end 406 may generate a second frame 432 based on frame data 420 and acceleration transform 455b. The ISP back end 406 may further generate frame data 432 based on local motion data 465, calculated based on differences in frames preceding and possibly including frame 420.

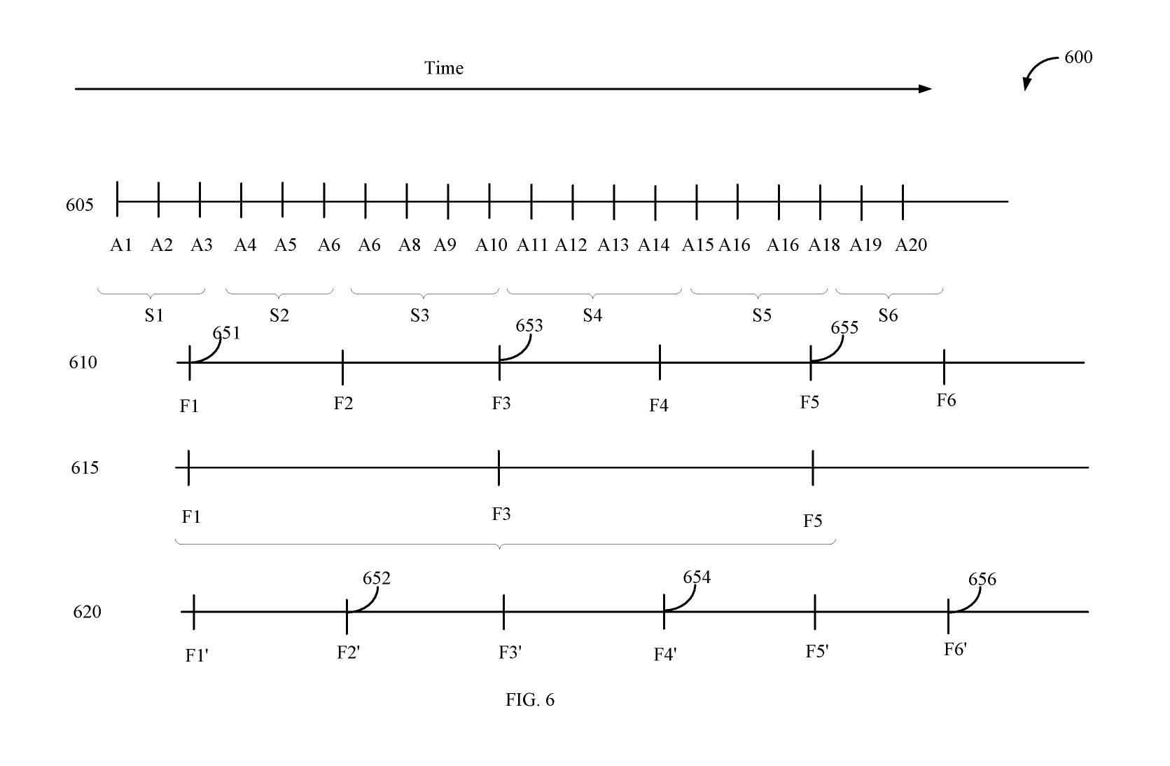

FIG. 6 is a timing diagram showing relative timing of acceleration measurements, processing of frames by an imaging pipeline, and an output image frame stream from the imaging pipeline. FIG. 6 shows a timeline 605 showing acceleration measurements A1-A20. These acceleration measurements A1-A20 are grouped into sets of measurements S1-S6 for ease of discussion below. Also shown is a second timeline 610, showing imaging frames F1-F6, which may be captured by an imaging sensor providing input to the imaging pipeline. A third timeline 615 is also shown. Timeline 615 shows a reduced number of frames relative to timeline 610. The frames on the timeline 615 may be processed by at least some components of the imaging pipeline. For example, in some aspects, while an imaging sensor may capture frames F1-F6, frames F2, F4, and F6 may be dropped to reduce processing requirements, with thus remaining frame F1, F3, and F5 processed by some components of the imaging pipeline while frames F2, F4, and F6 are not processed by those components. The frames F1, F3, and F5 on the timeline 615 are unstabilized frames. Thus, no stabilization transform, generated based on measurements of timeline 605, have been applied to the frames F1, F3, and F5 on timeline 615.

FIG. 6 also shows a timeline 620. Timeline 620 shows a set of image frames that may be generated by the imaging pipeline. In some aspects, the frames shown on timeline 620 may be stabilized versions of the frames shown on timeline 615. For example, frame F1′ may be generated by applying a stabilization transform, created based on acceleration measurements in set S1 for example, on frame F1. Frame F3′ may be generated by applying a stabilization transform to frame F3. The stabilization transform for frame F3 may be based, for example, on acceleration set S3 of timeline 605. Frame F5′ may be generated by applying a stabilization transform to frame F5. The stabilization transform may be based on acceleration measurements in set S5.

F2′, F4′, and F6′ may be generated based on, for example, the frames F1, F3, and F5 respectively. The frames F2′, F4′, and F6′ may be interleaved within the frames F1, F3, and F6, to form a new image stream along timeline 620, that has a higher frame rate than the frames on timeline 615. In some aspects, the frame rates on timelines 610 and 620 may be equivalent, but may not always be equivalent in all embodiments.

Additionally, each of the frames F2′, F4′, and F6′ may be generated based on acceleration measurements made during a time corresponding to their respective locations on the timeline 720. For example, frame F2′ may be generated based on at least frame F1 and one or more of the acceleration measurements with acceleration set S2, since accelerations S2 are recorded between a time of frame F1, labeled as 651, and a time represented by frame F2′, labeled as 652. Thus, note that while frame F1′ may be based on acceleration measurement set S1, F2′ may be based on acceleration measurement set S2. Both F1′ and F2 may be based on frame F1. Frame F4′ may be generated based on at least frame F3, and one or more acceleration measurements within acceleration set S4, as acceleration measurements S4 are taken between a time that frame F3 was captured, shown as 653, and a time represented by frame F4′ on the timeline 720, shown as 754. Frame F6′ may be generated based on at least frame F5, and one or more acceleration measurements within acceleration set S6, as acceleration measurements S6 are taken between a time that frame F5 was captured, shown as 755, and a time represented by frame F6′ on the timeline 720. The disclosed methods and systems may save power by generating frames F2′, F4′, and F6′ late in an imaging pipeline, while dropping frames F2, F4, and F6 early in the imaging pipeline. Of course, the timing diagram of FIG. 6 is just one example of how an imaging pipeline may operate, and the operation may vary from that disclosed in FIG. 6 in various embodiments or during different periods of time.

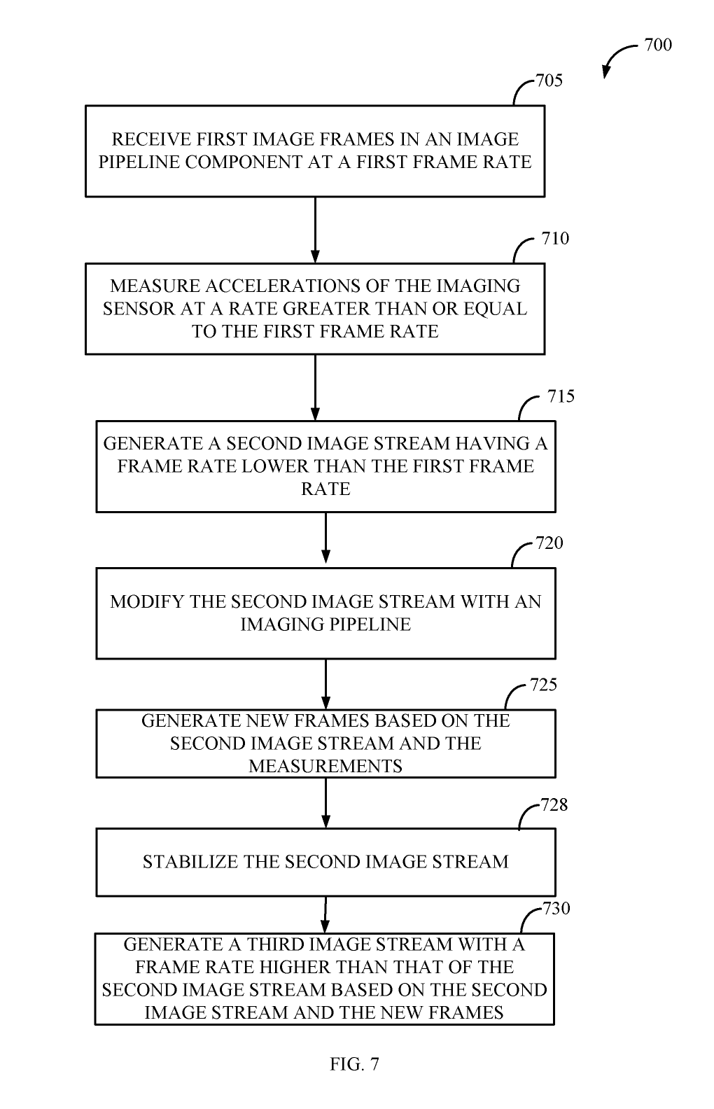

FIG. 7 is a flowchart of example for reducing power in an imaging pipeline, according to some embodiments. In some aspects, the process 700 discussed below with respect to FIG. 7 may be performed by the imaging pipeline 400, discussed above. For example, in some aspects, instructions included in one or more of the components described above with respect to any of FIG. 4 or 5 may configure an electronic hardware processor to perform one or more of the functions associated with process 700 and FIG. 7 as discussed below.

In some aspects, process 700 provides for reduced power consumption in an imaging pipeline. By processing only a portion of the frames generated by an imaging sensor at a particular frame rate, power is saved. For example, a number of memory operations may be reduced, due to the processing occurring at a lower rate than that generated by the imaging sensor. To compensate for the reduced frame rate processing, the reduced rate image stream is up-converted to a higher frame rate. This upconversion may be based on previous frames in the reduced frame rate stream, for example, to generate information relating to predicting motion in the upconverted frames. The upconversion may also be based on acceleration data received from a motion sensor, such as an accelerometer.

In block 705, image frames are received by an image pipeline component of an electronic device at a first frame rate. For example, in some aspects, the ISP front end 404 may receive image frames at the first rate from the imaging sensor 402. In some other aspects, a portion of frames generating by the imaging sensor 402 may be dropped so as to result in the first frame rate. The first image stream may include at least first and second image frames.

In block 710, accelerations of the imaging sensor are measured at a rate greater than the first frame rate. The accelerations may be measured while the image frames received in block 705 were captured. For example, the accelerations may include at least a first measurement of acceleration between the first and second image frames.

In block 715, a second image stream is generated having a lower frame rate than the first image stream. In some aspects, the second image stream may be generated by dropping frames from the first image frame. For example, in some aspects, frames may be dropped at a periodicity. For example, in some aspects, ½, ¾, or ¼ of the image frames of the first image stream may be dropped to generate the second image stream. In aspects that drop ½ of the frames, every other frame may be dropped from the first image stream. In aspects that drop ¼ of the frames, every fourth frame from the first image stream may be dropped to generate the second image stream. In some aspects that drop ¾ of the frames in the first image stream, every fourth frame in the first image stream may be used in the second image stream, while the three intervening frames may be dropped.

In block 720, the second image stream is modified by the imaging pipeline. For example, as discussed above with respect to FIG. 5, the ISP front end 404 may process data at a frame rate of the second image stream, which is lower than the frame rate of frames received from the image sensor 402. Thus, the ISP front end 404 may write data to a memory, such as memory 412, at a lower rate than if the ISP front end 404 processed every frame captured by the image sensor 402. Functions included in the ISP front end 404 may include one or more of black level correction, channel gains, demosaic, Bayer filtering, global tone mapping, and color conversion. These functions may “modify” the second image stream as described in block 720.

Some aspects of block 720 include clock gating at least portions of the imaging pipeline. For example, block 720 may include clock gating the ISP front end 404 when the ISP front end 404 would have otherwise processed frames removed from the first image stream to generate the second image stream. Since the second image stream includes fewer frames that the first image stream, hardware associated with processing the second image stream may be clock gated between processing of a first frame in the second image stream and a subsequent second frame in the second image frame. This may reduce power consumption when compared to the power that would be required to process the first image stream in block 720.

Block 720 may include, in some aspects, stabilizing the images of the second image stream

In block 725, new frames are generated based on the second image stream. For example, intra-frame motion vectors may be determined based on two frames preceding a new frame. For example, with respect to FIG. 6, the frames shown on timeline 610 may represent an example of a first image stream, while the frames shown in timeline 615 may represent an example of a second image stream.

Motion vectors based on differences between images represented by the frames F1 and F3 may be utilized to generate an intermediate frame F4′. For example, motion occurring in a scene represented by F1 and F3 may be used to position one or more image features within new frame F4′. Additionally F4′ may be generated based on inter-frame motion data received from acceleration measurements in set S4. For example, a stabilization transform may be generated by acceleration measurements for a time period before new frame F4's position in the timeline 620, such as measurement set S4. The stabilization transform may then be applied to the intermediate frame F4′ to generate the frame F4′ on timeline 620. In some aspects, frame F4′ is one of the new frames discussed with respect to block 725.

In block 728, the second image stream is stabilized. For example, in some aspects, timeline 615 represents an exemplary second image stream. Measurements from the accelerometer received in block 710 (timeline 605 of FIG. 6 represent exemplary measurements) may be utilized to stabilize the second image stream. A stabilization transform may be generated for each frame in the second image stream to provide for stabilized versions of frames in the second image stream. For example, as discussed in the example of FIG. 6, unstabilized frame F1 may be stabilized based on acceleration measurement set S1, unstabilized frame F3 may be stabilized based on acceleration measurement set S3, and unstabilized frame F5 may be stabilized based on acceleration measurement set S5. Thus, in some aspects, at the completion of block 728, frames F1′, F3′, and F5′ are exemplary frames of the stabilized second image stream.

In block 730, a third image stream may be generated based on the stabilized second image stream and the new frames generated in block 725. For example, the third image frame may be generated so as to have an increased frame rate relative to the second image frame, based on an addition of the new frames to the second image stream. In some aspects, the new frames may be interleaved between frames of the second image stream to generate the third image frame. In some aspects, the third image stream has a frame rate equivalent to that of the first image stream. For example, the new frames generated in block 725 compensate for frames dropped from the first image stream to generate the second image stream in some aspects.

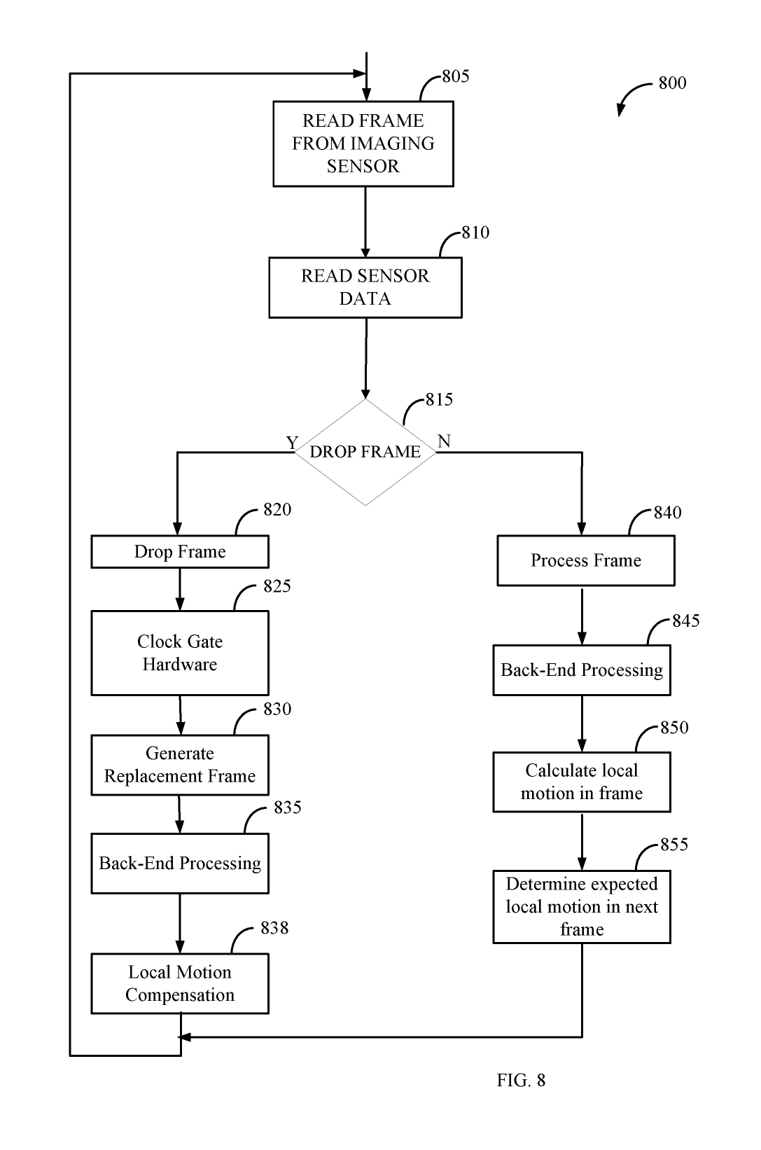

FIG. 8 is a flowchart for reducing power in an imaging pipeline. In some aspects, the process 800 discussed below with respect to FIG. 8 may be performed by the imaging pipeline 400, discussed above. For example, in some aspects, instructions included in one or more of the components described above with respect to any of FIG. 4 or 5 may configure an electronic hardware processor to perform one or more of the functions associated with process 800 and FIG. 8 as discussed below.

In some aspects, process 800 may be the same or nearly the same, to process 700, but illustrated and described in an alternative way. In some aspects, an embodiment of process 800 may operate in a completely different manner than a second embodiment operating under process 700. In some aspects, process 700 provides for reduced power consumption in an imaging pipeline. By processing only a portion of the frames generated by an imaging sensor at a particular frame rate, power is saved. For example, a number of memory operations may be reduced, due to the processing occurring at a lower rate than that generated by the imaging sensor. To compensate for the reduced frame rate processing, the reduced rate image stream is upconverted to a higher frame rate. This upconversion may be based on previous frames in the reduced frame rate stream, for example, to generate information relating to predicting motion in the upconverted frames. The upconversion may also be based on acceleration data received from a motion sensor, such as an accelerometer.

In block 805, a frame is read from an imaging sensor. The imaging sensor may generate frames at a first rate, for example, “2N,” with N being any constant value.

In block 810, sensor data may be read. For example, in some aspects, data may be read from the gyro 440 shown in FIG. 4, indicating accelerations of the device experienced over a recent time period. In some aspects, block 810 may collect the acceleration measurements illustrated in FIG. 6, timeline 605. Block 810 may also determine a stabilization transform based on the acceleration measurements. For example, a variance-stabilizing transformation may be calculated based on the frame read in block 805 and at least one previous frame.

Block 815 determines whether the frame should be dropped or not. In some aspects, frames may be dropped at various rates, depending on a variety of factors. For example, in some aspects, the rate at which frames are dropped may be based on a level of motion detected in the frames. In other aspects, the rate at which frames may be dropped may be based on a power state of a device performing process 800. For example, if the device performing process 800 is operating on battery power, or on battery power with a battery having a remaining energy level below a threshold, then frames may be dropped such that the remaining frames are at a rate below a frame rate threshold. In some aspects, if the device is operating on wall power, then frames may be dropped at a lower rate, or not dropped at all such that the remaining frames are above the frame rate threshold. In various aspects, block 815 may determine to drop ⅛, 1/7, ⅙, ⅕, ¼, ⅓, ½, ⅔, ¾ or any percentage of the frames received in block 805.

If decision block 815 determines not to drop the frame, then process 800 moves to block 840, where the frame is processed. In some aspects, processing the frame in block 840 may include front-end processing, for example, processing performed in block 404 discussed above. Front end processing may include one or more of black-level correction, channel gains, demosaic, Bayer filtering, global tone mapping, and color conversion.

In block 845, back-end processing is performed on the frame. In some aspects, back-end processing may include image stabilization. Image stabilization in block 845 may be based on at least acceleration measurements obtained in block 810 above.

Back-end processing may also include one or more of spatial de-noising, temporal de-noising, warping (stabilization, lens distortion correction), sharpening, and color processing.

In block 850, local motion in the frame may be determined. For example, in some aspects, the frame received from the image sensor in block 805 may be compared with previous frames received from the image sensor to determine intra-frame motion (motion within the frame itself). For example, block 850 may determine motion vectors for one or more objects in the frame. In some aspects, these motion vectors are based on relative positions of the objects in the previous frame and current frame (frame received in block 805).

In block 855, expected local motion in a next frame may be determined. For example, in some aspects, block 855 may predict the location of one or more objects represented by the frame based on motion vectors for the objects determined in block 840. After block 855 is complete, process 800 returns to block 805, where another frame is received from the imaging sensor and process 800 continues as described above and below.

If block 815 determines to drop a frame, then process 800 moves from block 815 to block 820, where the frame is dropped. In block 825, in some aspects, electronic hardware is clock gated. In other words, in these aspects, portions of computer hardware may be powered down for a time approximately equivalent to a processing time of block 840. Block 825 may represent power savings provided by the disclosed methods and systems. For example, while performing block 825, data may not be written to a memory, whereas block 830 may include one or more writes of the frame to a memory, thus consuming more power than block 825. In some aspects, clock gating may not be performed. In these aspects, block 825 may represent a time between two sequential image frames that is characterized by a reduced number of memory writes when compared to block 840. For example, in aspects that perform front-end processing in block 840, block 840 may include writing the frame received in block 805 to a memory. Given modern image sensor sizes, frames can be relatively large in size. Thus, writing this relatively large amount of data to a memory, and reading the data from a memory, can consume substantial amounts of power. By dropping the frame in 820 and essentially avoiding processing block 840 as represented by block 825, power consumption may be reduced. Thus, in some aspects, if clock gating is not performed in block 825, a hardware processor may “spin” in an idle loop. This spinning consumes less power than block 840, because it does not typically include writing/reading the image frame to/from a memory.

In block 830, a replacement frame is generated. In some aspects, generating a replacement frame may include copying a previous frame, for example, a frame previously processed and output by block 840. For example, to generate a new frame, a copy of a previous frame generated by the front end 404, or the process frame block 840, may be made. In some aspects, a replacement frame may not be generated for each dropped frame. For example, in some aspects, block 834 may generate two (2), three (3), four (4), five (5), or any number of frames to replace the frame dropped in block 820. In some other aspects, not every performance of block 820 may result in a replacement frame. For example, in some aspects, only one out of every two (2), three (3), four (4), five (5) or any number of performances of block 820 may result in a generation of a single replacement frame.

In some aspects, the number of replacement frames generated may be based on the number of frames dropped in block 820. For example, in some aspects, block 830 operates to maintain a stable output frame rate despite variations in the number of frames dropped by block 820.

In block 835, back-end processing may be performed on the replacement frame. Back-end processing may include one or more of spatial de-noising, temporal de-noising, warping (stabilization, lens distortion correction), sharpening, and color processing. Back-end processing may also include stabilization of the replacement frame. This may be based on the sensor data received in block 810. Note that when considering two iterations of process 800, in a first iteration, a first frame may be processed by blocks 840 and 845, referenced here as first frame 840 and first frame 845 respectively. In a second iteration following the first iteration, a second frame may be generated in block 830 by copying the first frame 840. The second frame is then processed by block 835 and stabilized. While the first frame 845 and second frames are both derived from the first frame 840, the second frame (the generated “replacement frame) may have a stabilization transform different than the first frame 840 stabilization transform when processed by block 845. This may be due to the two stabilization transforms being based on different acceleration measurements received in block 810. This is demonstrated in FIG. 2 above.

In block 838, local motion compensation may be performed on the replacement frame. In some aspects, the local motion compensation may be based on the expected local motion determined in block 855 for a previous frame.

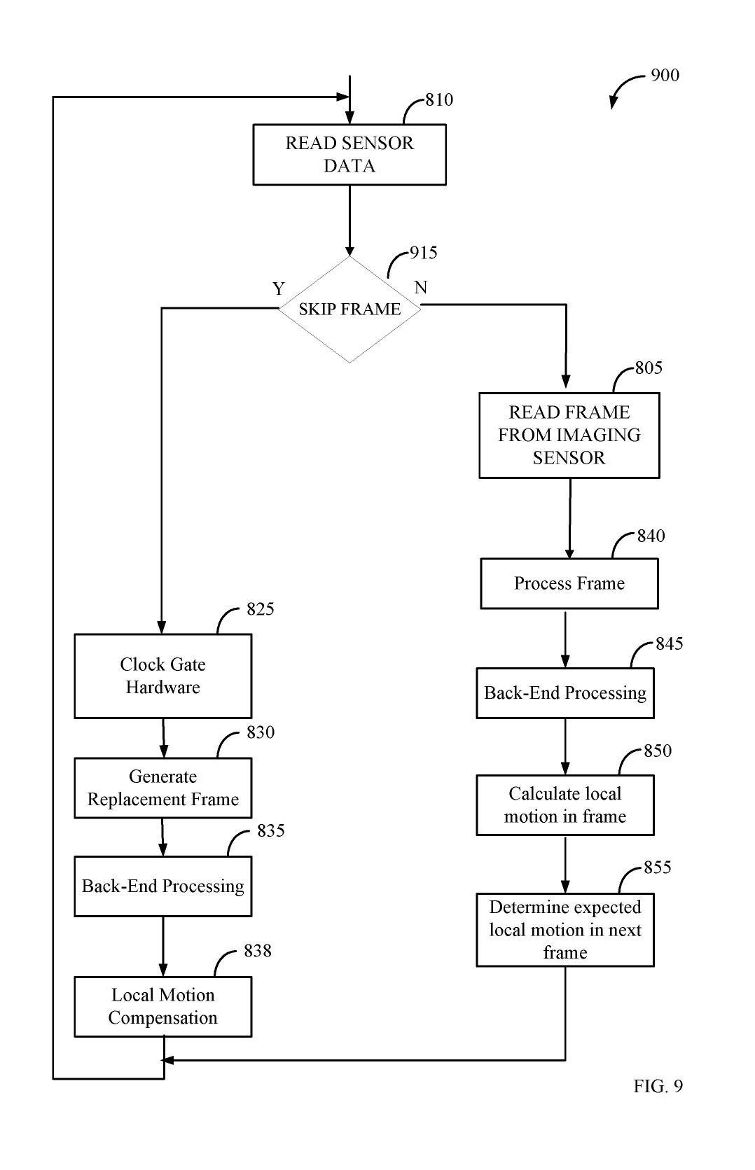

FIG. 9 is another exemplary method for reducing power consumption in an image pipeline. FIG. 9 illustrates a variation on process 800 discussed above, as process 900. Whereas in process 800, frames may be read from an imaging sensor and then dropped, in process 900, frames that might be dropped in process 800 are simply not read from the imaging sensor. Otherwise, blocks with equivalent numbers function in an equivalent manner as those discussed above with respect to FIG. 8.

One difference between process 800 and process 900 is whereas decision block 815 in process 800 determines whether a frame will be dropped, decision block 915 of process 900 determines whether a frame will be skipped (in other words, whether a frame will be read from an imaging sensor within a particular iteration of process 900). Otherwise, the two decision blocks (815 and 915) may operate in a similar manner. For example, criteria used to determine whether a frame is dropped in decision block 815 may be utilized to determine whether a frame is skipped in block 915.

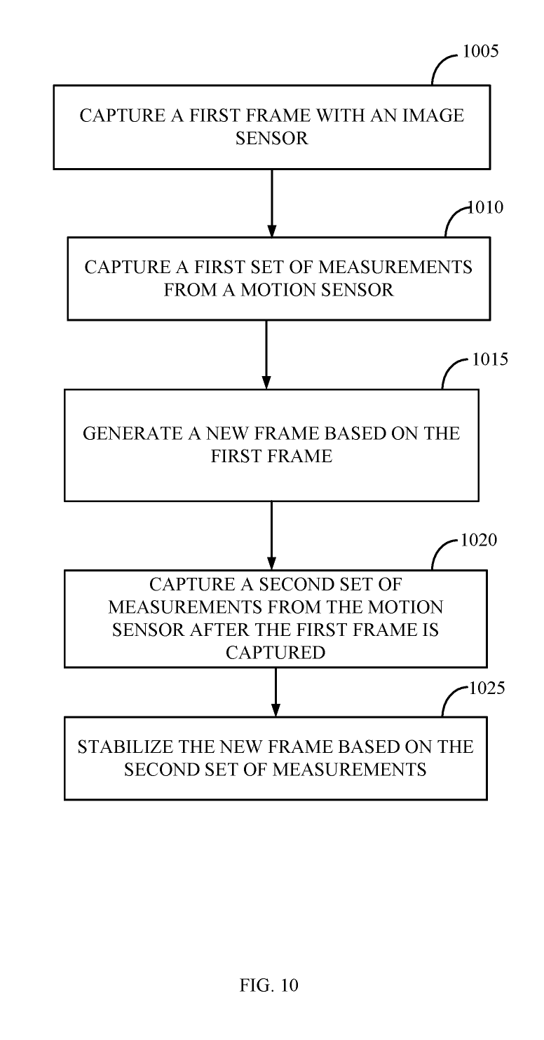

FIG. 10 is an exemplary method for stabilizing an image stream. Process 1000 discussed below with respect to FIG. 10 may occur, in some aspects, within of the processes 700, 800, or 900 discussed above. For example, block 1005 of FIG. 10 may occur within blocks 705, 805, 805 of FIGS. 7, 8, and 9 respectively. Block 1010 of FIG. 10 may occur within blocks 710, 810, and 810 of FIGS. 7,8, and 9 respectively. Block 1015 may occur within blocks 725, 830, 830 of FIGS. 7,8, and 9 respectively. Block 1020 may occur within blocks 710, 810, and 810 of FIGS. 7, 8, and 9 respectively. Block 1025 may occur within blocks 730, 835, and 835 of FIGS. 7, 8, and 9 respectively.

In block 1005 an image frame is captured by an image sensor. In some aspects, block 1005 may include an electronic hardware processor receiving the captured frame from the image sensor. For example, the image sensor 402 may capture an image, and a hardware processor may read the captured image as an image frame into a memory, such as the data memory 412. In some aspects, the hardware processor may read frames from the image sensor at a rate, such as a first rate. The first rate may be variable. For example, the rate may vary based on a level of motion detected in the images. If little motion is detected, the rate may be lower, with more motion resulting in a higher rate of frames from the image sensor.

In block 1010, a first set of measurements are captured from a motion sensor. The first set of measurements may be contemporaneous with the capture of the first image frame. For example, the measurements may represent motion of the image sensor at the time the first frame is captured in block 1005. As an example, FIG. 2 shows a unstabilized stream 220 including a frame 201a. The frame 201a may be an example of the first frame captured in block 1005. The gyro data from time T₁ of FIG. 2 (item 203a) is one example of the first set of measurement captured in block 1010. The frame F1 shown in FIG. 6 may be another example of the first frame captured in block 1005, with the acceleration measurements S1 an exemplar of the first set of measurements captured in block 1010.

In block 1015, a new frame is generated based on the first frame. As described above, in some aspects, after frame is processed by the front end 404, it may be copied to generate a second frame to frame rate up convert an image stream. An example of this is shown in FIG. 2, with frame 202b generated based on the unstabilized frame 201a.

In block 1020, a second set of measurements from the motion sensor are captured. The second set of measurements are captured after the first frame is captured from the image sensor. For example, as shown in FIG. 2, at time T₂, gyro data from T2 is captured. This gyro data 203b is collected after the image frame 201a was captured.

As another example, the set of measurements S2 shown in FIG. 6 are captured after the frame F1 is captured at time 651 in FIG. 6.

In block 1025, the new frame is stabilized based on the second set of measurements. As discussed above in FIG. 2, the new frame 202b is stabilized by the gyro data 203b. As another example, the frame F2′ is stabilized in FIG. 6 based on the set S2.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like. Further, a “channel width” as used herein may encompass or may also be referred to as a bandwidth in certain aspects.

As used herein, a phrase referring to “at least one of” a list of items refers to any combination of those items, including single members. As an example, “at least one of: a, b, or c” is intended to cover: a, b, c, a-b, a-c, b-c, and a-b-c.

As used herein, “coupled” may include communicatively coupled, electrically coupled, magnetically coupled, physically coupled, optically coupled, and combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive electrical signals (digital signals or analog signals) directly or indirectly, such as via one or more wires, buses, networks, etc.

The various operations of methods described above may be performed by any suitable means capable of performing the operations, such as various hardware and/or software component(s), circuits, and/or module(s). Generally, any operations illustrated in the figures may be performed by corresponding functional means capable of performing the operations.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Thus, in some aspects computer readable medium may comprise non-transitory computer readable medium (e.g., tangible media). In addition, in some aspects computer readable medium may comprise transitory computer readable medium (e.g., a signal). Combinations of the above should also be included within the scope of computer-readable media.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware or any combination thereof. If implemented in software, the functions may be stored as one or more instructions on a computer-readable medium. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray® disc where disks usually reproduce data magnetically, while discs reproduce data optically with lasers.

Thus, certain aspects may comprise a computer program product for performing the operations presented herein. For example, such a computer program product may comprise a computer readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

While the foregoing is directed to aspects of the present disclosure, other and further aspects of the disclosure may be devised without departing from the basic scope thereof, and the scope thereof is determined by the claims that follow.

1. An electronic device, comprising:
an image sensor configured to capture images;
a motion sensor, configured to measure motion of the image sensor;
an electronic hardware processor, configured to:
receive a frame captured by the image sensor;
receive a measurement of motion from the motion sensor, the measurement taken after the frame is captured; and
stabilize the frame based on the measurement.

2. The electronic device of claim 1, further comprising an electronic hardware memory, wherein the electronic hardware processor is configured to:
receive image frames from the image sensor at a first frame rate,
write a portion of the image frames to the electronic hardware memory at a second frame rate,
drop a remaining portion of the image frames,
enter a low power state in response to dropping an image frame,
exit the low power state in response to a capture of a next image frame at the first rate by the image sensor,
receive the image frames from the electronic hardware memory at the second frame rate,
generate new image frames based on the image frames received from the electronic hardware memory and the measurement, and
write the image frames received from the memory and the new frames to the electronic hardware memory at a rate higher than the second frame rate.

3. The electronic device of claim 2, wherein the electronic hardware processor is configured to
perform front-end processing on the portion of the image frames received from the image sensor at the first frame rate, and
perform back-end processing on the image frames received from the memory.

4. The electronic device of claim 2, wherein the electronic hardware processor is configured to vary a percentage of image frames dropped based on a level of motion detected in the received frames.

5. The electronic device of claim 2, wherein the front-end processing includes one or more of black-level correction, channel gains, demosaic, Bayer filter, global tone mapping, color conversion, and wherein the back-end processing comprises one or more of spatial de-noising, temporal de-noising, stabilization, lens distortion correction, sharpening, gamma correction, and color processing.

6. The electronic device of claim 2, wherein entering the low power state comprises clock gating the electronic hardware processor.

7. The electronic device of claim 1, further comprising a camera.

8. A wireless device with improved power consumption characteristics, comprising:
a motion sensor, configured to measure motion of the wireless device;
an image sensor configured to operate at a first frame rate using a first exposure time and to capture a first frame;
an electronic hardware processor configured to
receive the first frame from the image sensor;
generate a second frame based on the first frame;
stabilize the first frame using a first stabilization transform derived from a first set of measurements from the motion sensor; and
stabilize the second frame using a second stabilization transform derived from a second set of measurements from the motion sensor, the second set of measurements taken after the first frame is captured by the image sensor.

9. The device of claim 8, further comprising an electronic hardware memory, wherein the electronic hardware processor is configured to:
process frames from the image sensor at a second rate lower than the first frame rate and write the processed frames to the electronic hardware memory,
enter a lower power state between a time that the processing completes on the first frame and a next frame is received from the image sensor at the lower rate, and
read the processed frames from the electronic hardware memory at the second rate and to frame rate up convert the received frames based on the second frame.

10. The wireless device of claim 9, wherein the electronic hardware processor is configured to vary the second rate at which frames from the image sensor are processed based on a level of motion detected in the frames, and wherein the electronic hardware processor is configured to vary the rate of frame rate upconversion to achieve the first frame rate based on the variable second rate of frames.

11. The wireless device of claim 8, further comprising a battery, wherein the electronic hardware memory, image sensor, and electronic hardware processor are configured to draw power from the battery.

12. A method of reducing power consumption in an imaging device, comprising:
receiving, by an electronic device, a first image stream captured by an image sensor;
generating, by the electronic device, a second image stream based on the first image stream;
stabilizing, by the electronic device, each image in the first image stream based on first motion measurements taken contemporaneously with the capturing of the individual image; and
stabilizing, by the electronic device, the second image stream based on motion measurements interleaved with the first motion measurements.

13. The method of claim 12, wherein generating the second image stream comprises:
generating a first frame based on a second frame in the first image stream;
receiving measurements from a motion sensor, the measurements taken after the second frame was captured by the image sensor; and
stabilizing the first frame based on the received measurements.

14. The method of claim 12, further comprising interleaving the first and second image streams to generate a third image stream.

15. The method of claim 14, further comprising varying a rate at which frames are received from the image sensor based on a level of motion detected in the first image stream, wherein a rate of generation of frames in the second image stream is configured to adjust such that the third image stream achieves a stable frame rate as the periodicity of frame omitting varies.

16. The method of claim 13, further comprising
generating local motion vectors based on at least two frames in the first image stream; and
generating the second frame based on the local motion vectors applied to a most recent frame of the at least two frames.

17. The method of claim 12, further comprising performing front-end processing on the first image stream to generate a processed image stream, wherein the second image stream is based on the processed image stream, wherein front-end processing comprises one or more of Bayer filtering, demosaicing, black-level correction, adjusting channel gains, global tone mapping, and color conversion.

18. An apparatus for reducing power consumption in an imaging device, comprising:
an electronic hardware processor, configured to:
receive a first image stream captured by an image sensor,
generate a second image stream based on the first image stream,
stabilize each image in the first image stream based on first motion measurements taken contemporaneously with the capturing of the individual image, and
stabilize the second image stream based on motion measurements interleaved with the first motion measurements.

19. The apparatus of claim 18, wherein generating the second image stream comprises:
generating a first frame based on a second frame in the first image stream;
receiving measurements from a motion sensor, the measurements taken after the second frame was captured by the image sensor; and
stabilizing the first frame based on the received measurements.

20. The apparatus of claim 18, wherein the electronic hardware processor is configured to interleave the first and second image streams to generate a third image stream.

21. The apparatus of claim 20, wherein the electronic hardware processor is configured to vary a rate at which frames are received from the image sensor based on a level of motion detected in the first image stream, wherein the electronic hardware processor is configure to adjust a rate of generation of frames in the second image stream such that the third image stream achieves a stable frame rate as the rate at which frames are received from the image sensor varies.

22. The apparatus of claim 18, wherein the electronic hardware processor is configured to
generate local motion vectors based on at least two frames in the first image stream; and
generate the second frame based on the local motion vectors applied to a most recent frame of the at least two frames.

23. The apparatus of claim 18, wherein the electronic hardware processor is configured to perform front-end processing on the first image stream to generate a processed image stream, wherein the second image stream is based on the processed image stream, wherein front-end processing comprises one or more of Bayer filtering, demosaicing, black-level correction, adjusting channel gains, global tone mapping, and color conversion.
